(19) United States
(12) Patent Application Publication
(10) Pub. No.: US 2014/0087029 A1
(43) Pub. Date: Mar. 27, 2014

(54) DESSERT ON A SPOON

(71) Applicant: Pattie S. Lerner, Feasterville, PA (US)

(72) Inventor: Pattie S. Lerner, Feasterville, PA (US)

(21) Appl. No.: 14/039,566

(22) Filed: Sep. 27, 2013

Related U.S. Application Data
(60) Provisional application No. 61/706,443, filed on Sep. 27, 2012.

(51) Int. Cl. A23G 3/56

(52) U.S. Cl. CPC A23G 3/563
USPC 426/90

(57) ABSTRACT

Compositions comprising a dessert attached to a utensil by an edible attachment means are contained herein.

This application claims the benefit of U.S. Provisional Application No. 61/706,443, filed Sep. 27, 2012, which is incorporated herein by reference as if fully set forth.

### FIELD OF INVENTION

The disclosure relates to a dessert attached to a utensil.

### BRIEF DESCRIPTION OF THE DRAWINGS

FIG. 1 illustrates an embodiment of a dessert on a spoon.

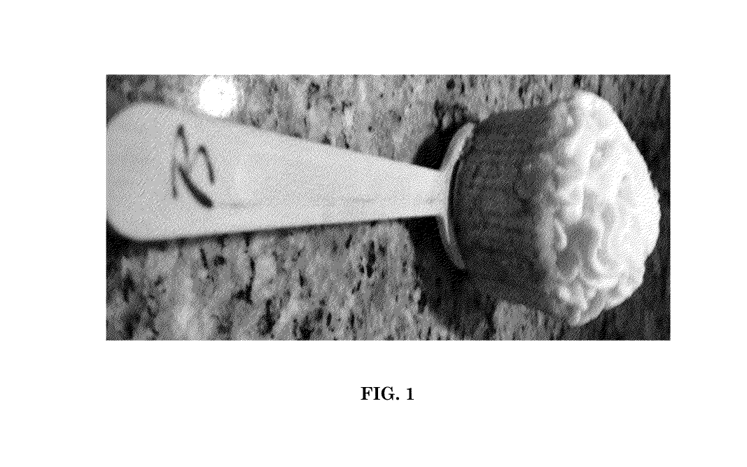

### DETAILED DESCRIPTION OF THE PREFERRED EMBODIMENTS

Certain terminology is used in the following description for convenience only and is not limiting. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

Embodiments include desserts attached to utensils. Desserts may include any dessert. Desserts may include cupcakes, truffles or muffins. Utensils may include any utensil capable of supporting a dessert. Utensils may include a spoon. A spoon may include a wooden spoon. Desserts may be attached to the utensil using an edible attachment means. An edible attachment means may include any food product capable of attaching a dessert to a utensil. An edible attachment means may include chocolate. Chocolate may include liquid milk chocolate, liquid white chocolate or liquid dark chocolate. In an embodiment, the dessert is attached to the utensil by liquid chocolate. The dessert, chocolate, utensil combination is allowed to cool and then frozen. The dessert is decorated and then the dessert, chocolate, utensil combination is frozen again. The dessert, chocolate, utensil combination may then be packaged. The packaged dessert, chocolate, utensil combination may be displayed on a stand.

Any single embodiment herein may be supplemented with one or more element from any one or more other embodiment herein.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A composition comprising a dessert attached to a utensil by an edible attachment means.
